(19) United States
(12) Patent Application Publication
(10) Pub. No.: US 2017/0032589 A1
(43) Pub. Date: Feb. 2, 2017

(54) DISTRIBUTED VEHICULAR DATA MANAGEMENT SYSTEMS

(71) Applicant: FORD GLOBAL TECHNOLOGIES, LLC, Dearborn, MI (US)

(72) Inventors: Jovan Milivoje ZAGAJAC, Ann Arbor, MI (US); Piotr MIANOWSKI, Livonia, MI (US)

(21) Appl. No.: 15/221,175

(22) Filed: Jul. 27, 2016

(30) Foreign Application Priority Data
Jul. 30, 2015 (GB) 1513470.3

(51) Int. Cl. G07C 5/00; H04W 4/00; H04L 29/08; G07C 5/08; B60R 16/023

(52) U.S. Cl. CPC G07C 5/008; G07C 5/0841; B60R 16/0232; H04L 67/12; H04L 67/1097; H04W 4/008

(57) ABSTRACT

An orchestration manager is provided. The orchestration manager is provided for instigating on demand vehicle information exchange between a plurality of vehicles and a remote server. The orchestration manager is configured to: queue, prioritize and send data requests to one or more vehicles, process data received from the, or each, vehicle; and deliver data request responses to the remote server.

### CROSS-REFERENCE TO RELATED APPLICATIONS

This application claims foreign priority benefits under 35 U.S.C. §119(a)-(d) to GB 1513470.3 filed Jul. 30, 2015, which is hereby incorporated by reference in its entirety.

### TECHNICAL FIELD

This invention relates to improvements in or relating to management of data obtained from and stored in a vehicle and, in particular, to increasing the efficiency of communication of the data to remote locations such as the cloud within the context of connected vehicles.

### BACKGROUND

There has been an increase in the number of sensors in vehicles sensing a plethora of vehicle, user and engine data. Some of the data is intended for use internally via a series of feedback loops within the vehicle. For example, the vehicle cabin temperature may be monitored in order to ascertain whether the air conditioning system has achieved the target vehicle cabin temperature.

A proportion of the data from the sensors is stored in vehicle systems. Depending on the nature of the system, the data may be stored indefinitely or it may be stored until a further measurement of the same parameter is made, at which point the earlier data may be overwritten with the new data.

In order to harvest intelligence from this growing wealth of data stored within a vehicle, it is known to communicate the data externally to the vehicle. For example, when a problem arises with a vehicle, it is well known for an operative to connect to the vehicle system via a portal device such as a laptop computer in order to review the data stored within the vehicle which may explain the fault.

Furthermore, it is known to provide data streaming to a cloud storage device where data may be analyzed.

Intelligent vehicular transportation systems are also known, for example as set out in US2014380264 (Tata) which harness the power of the vehicle users' smart phones to channel information pertaining to anomalies in the vehicles, road conditions, driving habits of the driver, environmental conditions and passenger behaviors. This data is streamed from the smart phones to the cloud where it may be further processed. In line with many smart phone data streaming protocols, data is typically pushed from the vehicle to the cloud.

US2009170537 discloses a method for deferring a telematics data upload from a vehicle equipped with wireless telephony and wireless networking communications devices. The disclosed methods focus of deferring communication when one mode of communication is not available.

US2006253235 discloses a method of wireless communication with a device. The method includes accessing diagnostic information associated with the device and providing the diagnostic information over an air interface. The disclosure focusses on obtaining data wirelessly.

US2013274950 discloses a system for triggered request for downloaded information from a vehicle-based monitor comprises a transmitter, a receiver, and a processor. The disclosure focuses on the client-server concept.

### SUMMARY

It is against this background that the present invention has arisen.

According to the present invention there is provided an orchestration manager, for instigating on demand vehicle information exchange between a plurality of vehicles and a remote server; wherein the orchestration manager is configured to: queue, prioritize and send data requests to one or more vehicles, process data received from the, or each, vehicle; and deliver data request responses to the remote server.

The orchestration manager may be further configured to share information with an information customer. The orchestration manager may further be deployed within the cloud.

Each of the plurality of vehicles may comprise a plurality of sensors for obtaining data indicative of the status of at least one parameter of the vehicle; a memory for storing the data obtained from the or each sensor; a processor configured to process and analyses at least a proportion of the data to create meta-data; one or more communication devices configured to receive a data query from a remote server; a controller configured to select data or meta-data appropriate to respond to the query and further configured to identify the appropriate communication device by which to send the data or meta-data and also to schedule the transfer of the data to the remote server.

The present invention provides considerable advantages over current systems in that it manages the data so that only the data or meta-data required is transmitted to the remote server. This considerably reduces the volume of data requiring transfer. Furthermore, because some of the data may be processed to form meta-data prior to being transferred, the data may be anonymized by the processing activity.

For example, instead of streaming a plurality of GPS location points to the remote server, the on board processing on the vehicle may store the multiple GPS location points and, only when requested by the server, it may process this data to calculate the length of the journey. From a privacy perspective, the on board processing has a considerable advantage in that the server does not learn the location of the vehicle, only the length of the journey. Communication with the server is effectively on a “need to know” basis, rather than a default state.

The present invention provides a step change in the approach to data transfer in that the data is only transferred in response to a request for the data. The data that is transferred may be meta-data that has been created from the data provided by the sensors. In addition, the smart selection of communication device and compression schemes further aids the cost efficient transfer of data.

The sensors may measure one or more engine parameters including fuel level, percentage NOx conversion, selective catalytic reduction (SCR) temperature, catalytic converter temperature, diesel particulate filter (DPF) filter status, oil level, and/or battery charge level.

The sensors may measure one or more vehicle parameters including vehicle speed, vehicle location, and/or proximity to adjacent vehicle and ambient temperature adjacent to the vehicle.

The sensors may measure one or more user parameters including number of people in the vehicle, radio station playing in the vehicle, CO level in the cabin, and/or temperature in the cabin.

The communication devices may be selected from a group including an embedded modem and a Wireless Local Area Network such as WiFi. For example, if both a modem and WiFi capability are provided then data can be provided across the WiFi when the vehicle is parked at home and connected to the home WiFi. This may be useful, for example, when data requested by the server relates to data aggregated throughout the day so that when the vehicle returns home data can be processed and communicated via the WiFi in response to the query raised by the remote server. Such data handling may also be appropriate for data not immediately needed by the requestor.

The management of data between different communication devices also allows the cost associated with data transfer to be effectively managed. The cost of sending data using the modem may fluctuate due to peak and off peak tariffs for data transfer. By managing the timing as well as the communication device deployed, the cost of the data transfer can be minimized. For example, if data can be aggregated and requests queued until an off peak tariff is applicable, then all of the requested data or meta-data can be transferred when an off peak tariff is applicable. Alternatively, or additionally, if the response to the query can be held until the vehicle can reasonably be expected to return home where the data transfer can take place via WiFi, then the data processed in response to queries from the remote server can be queued until the vehicle returns home.

The system may further comprise an information aggregation manager which may be configured to process the information received from one or more vehicles.

The system may further comprise a request processor which may be configured to compute an aggregate response to the original data request on the basis of the data received from the vehicles. The request processor may be further configured to analyze the request and create a message to be sent to one or more vehicles.

The system may further comprise a fleet manager and privacy manager configured to determine a subset of vehicles that should receive the message.

The system may further comprise a communication manager configured to verify the authenticity of a data request.

Furthermore, according to the present invention there is provided a data manager for use on a vehicle, the data manager configured: to record data from a plurality of sensors; to compress and save the data locally on the vehicle; to process the data locally on the vehicle to create meta-data; and to provide (potentially anonymized) meta-data to a remote server in response to an interrogation by the server.

The data manager is particularly focused on the privacy of the vehicle user. Whilst it receives requests from the server, it is configured to ensure that all the data or meta-data that is sent to the server is compatible with the privacy of the vehicle user. For example, the data manager could be configured to ensure that the location of the vehicle could not be ascertained by the remote server. The use of GPS location data would therefore be limited to ascertaining the length of a journey. Alternatively, the GPS location data itself may be accessed when the vehicle is identified to be on a major road, freeway, motorway or autobahn. If the vehicle is identified as being in such a location, then the location data of the vehicle may be aggregated by the server with the location data from other vehicles to identify traffic issues on such roads.

The data manager may also focus particularly on the privacy of a child or infant passenger. It will be apparent from the occupancy sensors that may be used in conjunction with seat belt reminder warnings, when a child or infant is in the vehicle. The vehicle may take a number of short journeys and, after one journey, the occupancy sensor may indicate that child passenger may no longer be present. This would be compatible, for example, with the child being dropped off at a location away from the home. In order to protect the privacy of the child, the location that the vehicle stopped when the child passenger did not return to the vehicle would not be communicated to the remote server as this would allow the location of the child to be ascertained.

The data manager may have user editable settings that enable the user to set up “private zones”. When a vehicle is identified as being within a “private zone” the vehicle location cannot be shared. A user could set up a “private zone” around the home, child's school and user's place of work or any other location where the vehicle is habitually left unattended for an extended period so that the location of the unattended vehicle cannot be ascertained.

The data manager may place further restrictions of the data requested in respect of the vehicle speed and location. The data manager may be configured to ensure that the data provided by the vehicle should not allow the remote server to ascertain whether the vehicle was being driven in violation of the speed limit on a particular section of road.

It is well known for a user's smart phone to be in Bluetooth communication with the audio system within the vehicle. This functionality allows the user to call legally on their phone with the sound routed via the vehicle's audio system. However, in order to achieve this functionality, the user may control their phone via the vehicle audio system. The data manager may be further configured to ensure that any data input from the user's smart phone when it is being used to make calls, cannot be passed through to the server. For example, the number dialed and the duration of the call would probably be known within the system, but the data manager may be configured to ensure that this information cannot be handed on to the remote server.

A server configured: to send queries to a plurality of vehicles; to receive responses from each of the vehicles; to further process the data to provide meta-data.

The server may be provided in the cloud. The server may be provided by a vehicle manufacturer and be applicable to all vehicles manufactured and fitted with the system. Alternatively or additionally the server may be provided by a provider a hire purchase vehicles or a fleet manager having control of a fleet of vehicles.

Each query may be configured to include a deadline for response. For example, the server may wish to obtain and aggregate data pertaining to the activity of a fleet of vehicles on a given day. If one of the vehicles in the fleet was not active on the relevant day, then the request has no meaning to that vehicle. By setting a deadline for response, it will be apparent which vehicles have not been active during the relevant period and the server can process the data received appropriately, without being delayed awaiting data from inactive vehicles.

The provision of a deadline for response also enables the system within the vehicle to select the most appropriate communication device for sending the data and time to communicate. For example, if the deadline for response is midnight, then there is no need to use the comparatively expensive modem communication if the vehicle can be expected to return home before midnight and therefore take advantage of the WiFi connectivity in the home location.

The invention will now be further and more particularly described, by way of example only, and with reference to the accompanying drawings, in which:

### BRIEF DESCRIPTION OF THE DRAWINGS

FIGS. 1A and 1B show a broad conceptual overview of the current approach and the proposed strategy, respectively;

FIG. 2 shows a further example of the present invention;

FIG. 3 shows further detail of a connected vehicle data hub; and

FIG. 4 shows further detail of a connected vehicle data node executed within a vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

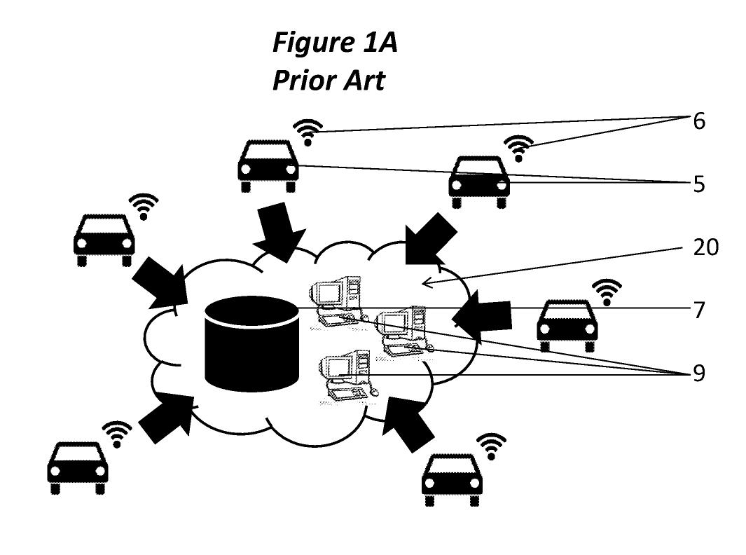

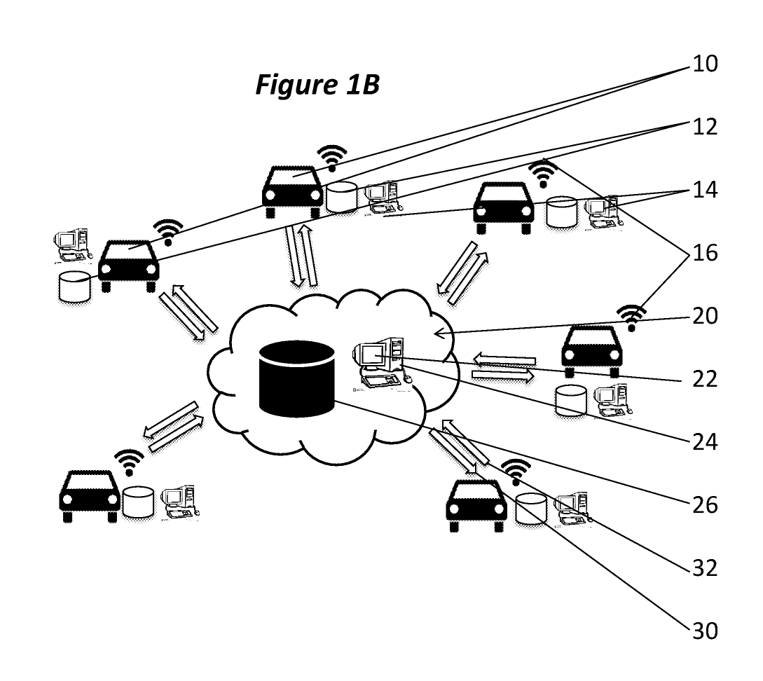

FIG. 1A shows an example of an existing telematics approach comprising a plurality of vehicles 5, each provided with a modem 6. The vehicles 5 continuously stream data generated on the vehicle via the modem 6 to a cloud based data store 7 in the cloud 20. The cloud 20 also includes data processing 9 which enables the data to be processed and analyzed.

FIG. 1B shows an example of a distributed system according to the present invention. Each vehicle 10 includes local data storage 12, a data processing device 14, and a communication device 16. The data is all stored in the data storage device 12, which is typically memory which may be located within a computer which embodies the data processing device 14. All of the data is stored so that it can be processed, or further processed at a later stage.

The provision of a data processing device 14 on the vehicle makes possible more intensive processing of high sample vehicle data. In this context, high can include data sampled up to 1000s of Hz. This local processing of such high sample vehicle data allows compression, real time analytics and feedback that would not be possible where all of the processing were to be executed remotely because the rate of data transfer would be prohibitive and the time delay in achieving analysis of the data and feedback would be too great.

The provision of a data processing device 14 on each vehicle 10 allows considerable parallel processing of data as each vehicle processes data simultaneously and locally.

At a remote, centralized location there is a remote server 22 and data processor 24 together with some data storage 26. This centralized location is typically in the cloud 20. Unlike the current system illustrated in FIG. 1A, the system of the present invention is configured for two way information exchange between the remote server 22 and the vehicles 10.

In this example, the communication starts with a query 30 being sent from the remote server 22 to the vehicles 10. In response to this query 30, a response 32 is sent from the vehicle 10 to the remote server 22. The response 32 includes data from the vehicle. This data will have been at least selected from the data set existing on the vehicle or, more likely, the data will have been pre-processed on the vehicle 10 using the data processing device 14 so that the data sent in the response 32 is an aggregate or average or calculated value from a larger data set that remains stored on the vehicle 10. An example of selected data is the maximum temperature of coolant. An example of processed data is the total distance travelled where this is calculated from a stream of GPS position data recorded at predetermined intervals throughout the day.

Because there is provision for local data storage 12 within the vehicle 10 there is no requirement for all of the data to be transmitted to the cloud 20 for storage. As a result, the only data that is transmitted is that which is requested by the remote server 22. This means that significantly less data is transmitted.

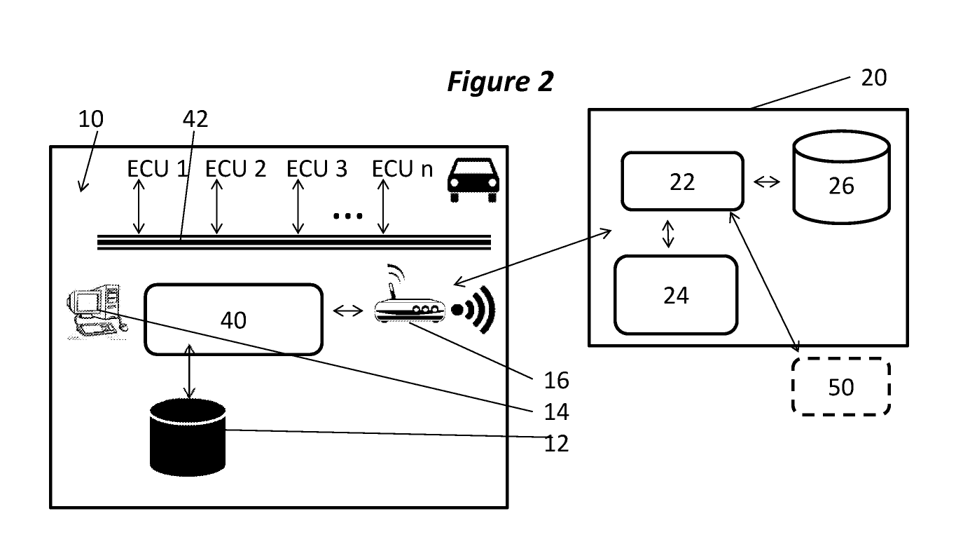

FIG. 2 shows further details of the system on the vehicle 10 and also the connected data hub located on the cloud 20. The vehicle 10 has the data storage 12, data processing device 14 and communication device 16. The communication between these integers is supported by a connected vehicle agent or data manager 40 which acts as a mediator to receive and interpret queries from the remote server located in the cloud 20. The data manager 40 also controls the selection of data from the vehicle for submission to the remote server 22 in the form of a response 32.

The data manager 40 can also manage driver privacy issues by vetting the data which is requested and communicated to the remote server 22. Because the majority of the data recorded by the vehicle 10 is stored on the vehicle, the default position is that no personal data is released to the remote server 22. The remote server 22 may make requests that the data manager 40 interprets as being a threat to the privacy of the user. In this instance, the data manager 40 may send only a partial response to the query 30 or may request an alternative query if answering the query 30 in its original form would compromise the privacy of the user.

The data is received from the sensors via a vehicle bus 42 which communicates with various ECUs which are, in turn, connected to sensors (not shown) which sense the conditions in different parts of the engine, cabin and vehicle as a whole. The conditions sensed include, inter alia, the temperature, pressure, gaseous composition present, vehicle location, speed, fuel level. Each ECU may be configured to manage data from a particular region of the vehicle. Within each region various different parameters may be sensed. For example, ECU1 may manage the DPF and may manage data received from a pressure sensor identifying the back pressure through the DPF; the temperature of the DPF and the particulate level in the exhaust gas passing through the DPF.

The remote server 22 receives data from the vehicle 10 and stores this data within data storage 26. The remote server 22 acts as an orchestration manager instigating the on demand vehicle information exchange. In addition, the orchestration manager is connected to an information aggregation manager 28 which acts as data processor 24 acting on the information received from one or more vehicles.

In addition to communication between the remote server 22 and the vehicles 10, information can also be made available to an information customer 50.

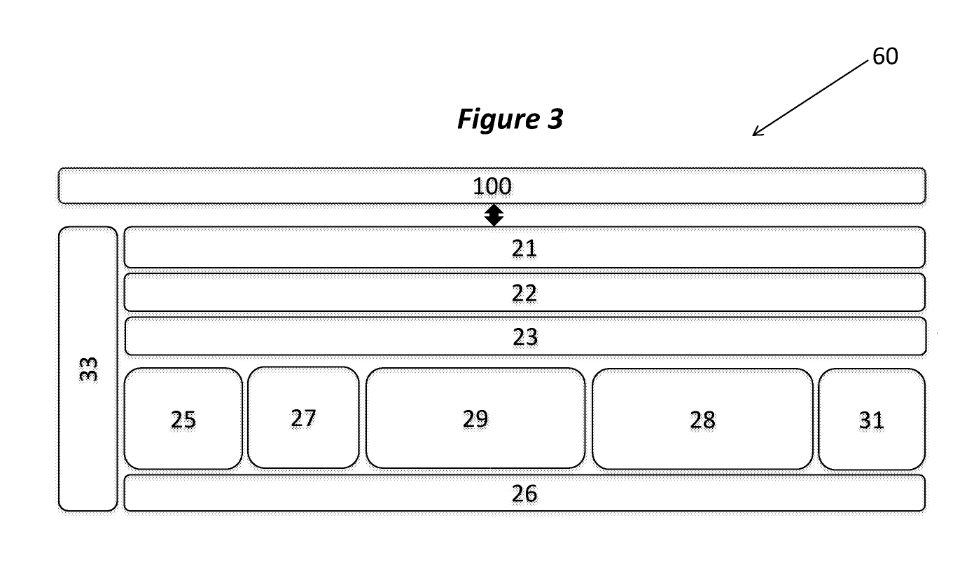

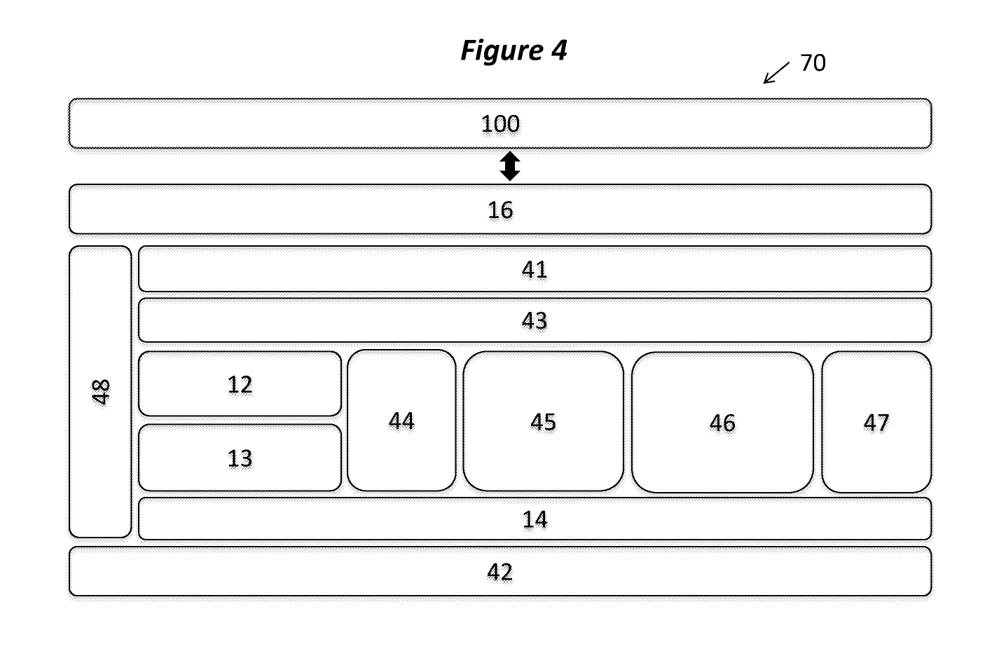

FIG. 3 shows further detail of a connected vehicle data hub 60 and FIG. 4 shows further detail of a connected vehicle data node 70 executed within a vehicle 10. Reference numerals for integers described with reference to previous figures are maintained for clarity.

FIG. 3 shows the various parts of the connected vehicle data hub 60 which is typically deployed within the cloud 20. There is provided communication across the network 100. This communication is controlled by a communication manager 21 which in turn communicates with the orchestration manager 22 and a request processor 23. The request processor 23 communicates with a fleet manager 25, a privacy manager 27, a vehicle data exchange language processor 29 and a software manager 31. A security manager 33 is provided to overlay all levels of communication within the connected vehicle data hub 60.

The functions of these various integers are set out as follows: the communication manager 21 is responsible for sending and receiving messages to and from the node 70 located on a vehicle 10. The orchestration manager 22 is responsible for queueing, prioritizing, and sending data requests 30 to one or more vehicles 10 within a vehicle fleet. In addition, the orchestration manager 22 is responsible for processing data received from connected vehicle data (CVD) nodes 70 and for delivering data request responses. The request processor 23 is responsible for the execution of a data request or query 30. The vehicle data analytics and aggregation manager 28 is responsible of performing analytics on set of data messages returned by CVD nodes 70 based on given data request. The vehicle data exchange language processor 29 is responsible for creating vehicle data requests and generating requests to vehicle data analytics and aggregation manager 28.

In addition, the fleet manager 25 maintains a list of all vehicles 10 registered with connected vehicle data hub 60; maintains privacy settings for each vehicle 10 and determines vehicle scope for a given data request or query 30. The privacy manager 27 collects privacy settings of all CVD nodes 70 and provides list of vehicles 10 that can receive given data request or query 30. The security manager 33 is responsible for message security: encryption, authorization, and authentication of data in transit. The security manager 33 is also responsible for data security: encryption of data in rest. Furthermore, the security manager is configured to manage operational security, for example DDoS attacks. The software manager 31 is responsible for firmware, operating system, configuration, and software module updates sent to CVD nodes 70.

FIG. 4 shows the various part of the connected vehicle data node 70 executed within a vehicle 10. There is provided communication across the network 100. This communication takes place via a vehicle modem 16 or other communication device. The communication is controlled by a vehicle communication manager 41 which, in turn, communicates with a vehicle orchestration manager 43. The vehicle orchestration manager 43 communicates with data storage 12, a privacy manager 44, a vehicle data exchange language processor 45, a vehicle data analytics and computation manager 46 and a software manager 47. The efficient functioning of the data storage 12 is complemented by the provision of a context based data compression manager 13. Data is obtained from the CAN bus 42 and this data is processed in the CAN data semantic processor 14. A security manager 48 is provided to overlay all levels of communication within the vehicle data node 70.

The node 70 operates when the CAN data semantic processor 14 collects base messages from the CAN bus 42 and translates them to name-values pairs using the vocabulary and dictionary in the vehicle data exchange language processor 45. The translated tuples are then sent to the context based data compression manager 13 for processing and local storage within the data storage 12. The vehicle meta-data is collected and stored alongside the base data within the data storage 12.

The functions of these various integers are set out as follows: The vehicle communication manager 41 manages the vehicle network interface and the cellular data volumes based on message priority i.e. instant delivery via cellular communications or delayed delivery via WiFi when the vehicle is in an appropriate WiFi-spot. The vehicle communication manager 41 is also responsible for sending and receiving message to and from the hub 60 as well as sending vehicle metadata/heartbeat to the hub 60 (this operation will be described in more detail below). The vehicle orchestration manager 43 is responsible for queueing and processing incoming data requests or queries 30 and for managing communication between separate device modules. The vehicle data analytics and computation manager 46 is responsible for all calculations performed on vehicle data and is capable of executing dynamic scripting included in data request or query 30. The vehicle data exchange language processor is responsible for interpreting vehicle data requests and generating request to vehicle data analytics and computation manager 46.

The context based data compression and storage manager 13 performs context based data compression to maximize storage utilization and maintains vehicle metadata. It is also responsible for vehicle data archival. The privacy manager 44 gives vehicle owner ability to set personal privacy filter (what data elements can be collected) and also the ability to set data element levels (at what level data can be collected (raw data vs aggregate data)). The CAN data semantic processor 14 manages CAN BUS interface and translates CAN data into unified vehicle data entities. The security manager 48 is responsible for message security: encryption, authorization, and authentication of data in transit. The security manager 48 is also responsible for data security: encryption of data in rest. In addition the security manager 48 manages operational security (DDoS attacks, etc.). The software manager 47 is responsible for firmware, operating system and software module updates via the network 100.

In addition to communications instigated by a query from the hub 60, vehicle meta-data and “heartbeat” data can be communicated from the vehicle 10 to the hub 60. This communication will take place at a predetermined cadence and may include changes in privacy policy; general geolocation and trip characteristics, vehicle communication diagnostics and vehicle status data. This information will be used by the vehicle data hub to maintain vehicle fleet data.

The steps that make up a vehicle data hub data request are as follows:

Step 1—Vehicle Data Hub 60 Receives Data Request

When the connected vehicle data hub 60 receives a data request (e.g. “What was an average speed of vehicles in Wayne county last month?”), communication manager 21 will verify message authenticity and pass it on to orchestration manager 22.

Orchestration manager 22 will determine request type and priority and place it in the proper request queue. When the request is ready to be executed, request processor 23 will use vehicle data exchange language processor 29 to analyze the request and create a message to be sent to individual connected vehicle data nodes 70.

Fleet manager 25 and privacy manager 27 will determine subset of vehicles 10 that should receive the new message then orchestration manager 22 will request communication manager 21 to send out the messages.

Step 2—Vehicle Data Node 70 Receives Data Request

When an individual connected vehicle data node 70 receives a message from the hub 60, vehicle communication manager 41 will verify message authenticity and pass it on to vehicle orchestration manager 43.

Vehicle orchestration manager 43 will use vehicle data exchange language processor 45 in conjunction with analytics and computation manager 46 to performed requested operation in accordance with privacy policy provided by privacy manager 44.

Local data storage 12 will be used to calculate requested results. The return message 32 will be send back to connected vehicle data hub 60 for processing.

Step 3—Vehicle Data Hub 60 Receives An Individual Data Result From A Vehicle 10

Connected vehicle data hub 60 will collect all returned messages for a given data request 30.

Once all sent out messages are returned or predefined timeout is reached, request processor 23 will use vehicle data analytics and computation manager 28 to compute aggregate response to the original data request. This second aggregation of data is important as it allows the original query to be answered with a single response, rather than a vehicle-by-vehicle response. This also enables the data to be effectively anonymized as any facet of the data that could be used to identify the source of the data can be removed at this stage.

As an example of the above three steps, if the request received by the data hub is “How many vehicles had an average trip length of less than 5miles?” then the orchestration manager 22 may formulate a query “what is your average trip length?” The orchestration manager 22 could send this to all vehicles, but if some vehicles within the fleet specialize in long distance transfers, then it may be deemed unnecessary to pole these vehicles. The request may therefore be sent to a subset of vehicles.

On receipt of this query, the vehicle orchestration manager 43 will use vehicle data exchange language processor 45 to perform a first data aggregation, calculating the length of each trip based on individual GPS coordinates of the vehicle over time. Each of these trips can then be aggregated to calculate the average trip distance. The privacy manager 44 will ensure that there is no remaining GPS trace identifying the actual location of the vehicle at any time. Time stamps may also be removed to prevent the speed of the vehicle being ascertained from the data.

When the vehicle is connected, via a suitable communication means, to the data hub 60, a message will be sent in response. This may be exemplified by “Vehicle x has average trip length of 10.5 miles.”

When all of the responses have been received from the selected vehicles, or a predetermined timeout is reached, which suggests that certain vehicles have not been suitably connected at any time within the period permitted for providing a response, the request processor 23 will aggregate the data, selecting a binary reading for each vehicle response: i.e. a 1 for less than 5 miles average trip length and a 0 for more than 5 miles average trip length. The request processor will add up all of the vehicles posting less than 5 miles average trip length, for example 327 vehicles. The response provided to the original query will be simply “327.”

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An orchestration manager, for instigating on demand vehicle information exchange between a plurality of vehicles and a remote server; wherein the orchestration manager is configured to:
queue, prioritize and send data requests to one or more vehicles, process data received from the, or each, vehicle; and
deliver data request responses to the remote server.

2. The orchestration manager according to claim 1, further configured to share information with an information customer.

3. The orchestration manager according to claim 1, being deployed within a cloud computing system.

4. A system for collating and processing data from a plurality of vehicles, the system comprising:
an orchestration manager for processing the data from the plurality of vehicles, each vehicle comprising
a plurality of sensors for obtaining data indicative of a status of at least one parameter of the vehicle;
a memory for storing the data obtained from at least a subset of the plurality of sensors;
a processor configured to process and analyze at least a proportion of the data to create meta-data;
one or more communication devices configured to receive a data query from a remote server; and
a controller configured to select data or meta-data to respond to the query and further configured to identify one of the communication devices by which to send the data or meta-data and also to schedule transfer of the data to the remote server.

5. The system according to claim 4, wherein the sensors measure one or more engine parameters including fuel level, percentage NOx conversion, selective catalytic reduction (SCR) temperature, catalytic converter temperature, diesel particulate filter (DPF) filter status, oil level, or battery charge level.

6. The system according to claim 4, wherein the sensors measure one or more vehicle parameters including vehicle speed, vehicle location, or proximity to adjacent vehicle.

7. The system according to claim 4, wherein the sensors measure one or more user parameters including number of people in the vehicle, radio station playing in the vehicle, CO level in a cabin of a vehicle, or temperature in the cabin of a vehicle.

8. The system according to claim 4, wherein one of the communication devices is a modem.

9. The system according to claim 4, wherein one of the communication devices is configured to communicate via a Wireless Local Area Network.

10. The system according to claim 4, further comprising an information aggregation manager which is configured to process the data received from one or more vehicles.

11. The system according to claim 4, further comprising a request processor which is configured to compute an aggregate response to the original data request based on the data received from the vehicles.

12. The system according to claim 11, wherein the request processor is further configured to analyze the request and create a message to be sent to one or more vehicles.

13. The system according to claim 12, further comprising a fleet manager and privacy manager configured to determine a subset of vehicles that should receive the message.

14. The system according to claim 4, further comprising a communication manager configured to verify authenticity of a data request.

15. A method comprising:
storing data obtained from one or more vehicle sensors measuring at least one parameter of a vehicle;
receiving a data query from a remote server;
selecting data or meta-data to respond to the query;
identifying a communication device by which to send the data or meta-data; and
scheduling transfer of the data to the remote server.

16. The method of claim 15, wherein the sensors measure one or more engine parameters including fuel level, percentage NOx conversion, selective catalytic reduction (SCR) temperature, catalytic converter temperature, diesel particulate filter (DPF) filter status, oil level, or battery charge level.

17. The method of claim 15, wherein the sensors measure one or more vehicle parameters including vehicle speed, vehicle location, or proximity to adjacent vehicle.

18. The method of claim 15, wherein the sensors measure one or more user parameters including number of people in the vehicle, radio station playing in the vehicle, CO level in a cabin of the vehicle, or temperature in the cabin of the vehicle.

19. The method of claim 15, further comprising:
processing the data received from one or more vehicles;
computing an aggregate response to the original data request on based on the data received from the vehicles; and
analyzing the request and creating a message to be sent to one or more vehicles.

20. The method of claim 19, further comprising determining a subset of vehicles to receive the message.
